(19) United States
(12) Patent Application Publication
(10) Pub. No.: US 2023/0168930 A1
(43) Pub. Date: Jun. 1, 2023

(54) SYSTEM AND METHOD FOR GENERATING AT LEAST ONE TRIGGER CATEGORY

(71) Applicant: The Toronto-Dominion Bank, Toronto (CA)

(72) Inventors: Danielle Jacqueline NELLICH, Toronto (CA); Davide IANNUZZI, North York (CA); Adrian BLOY, Ottawa (CA); David REILLY, Toronto (CA); Goran ILKHANIZADEH, Ottawa (CA); Kimberley Jane MEDEL, Mississauga (CA); Devi Jeannelle SOONDARSINGH, Oakville (CA)

(73) Assignee: The Toronto-Dominion Bank, Toronto (CA)

(21) Appl. No.: 17/535,806

(22) Filed: Nov. 26, 2021

(51) Int. Cl. G06F 9/50

(52) U.S. Cl. CPC G06F 9/5005

(57) ABSTRACT

A computer server system comprises a communications module; a processor coupled with the communications module; and a memory coupled to the processor and storing processor-executable instructions which, when executed by the processor, configure the processor to analyze resource consumption data to identify at least one emerging resource requester; generate at least one trigger category that includes the at least one emerging resource requester and at least one other resource requester; receive, via the communications module and from a computing device, a request to present the at least one trigger category; and send, via the communications module and to the computing device, a signal causing the computing device to display an interface that includes a selectable option to accept the at least one trigger category.

### TECHNICAL FIELD

The present application relates to systems and methods for generating at least one trigger category.

### BACKGROUND

Resources may be provided to resource requesters. For example, computing resources may be provided to one or more software applications executing on a computer.

For resource management purposes, resource consumption data may be obtained. The resource consumption data may include a list of resource requesters and an amount of resources provided to each requester.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a table showing example resource consumption data according to an embodiment;

FIG. 6 is a flowchart showing operations performed by a server in generating at least one trigger category according to an embodiment;

FIG. 7 is an example interface displayed on a display screen of a computing device according to an embodiment;

FIG. 8 is a flowchart showing operations performed by a server in triggering an action according to an embodiment;

FIG. 9 is a flowchart showing operations performed by a server in providing an amount of a second type of resources to at least one resource collector according to an embodiment; and

FIG. 10 is a flowchart showing operations performed by a server in reducing the amount of resources provided to at least one resource requester that is not included in the at least one trigger category according to an embodiment.

Like reference numerals are used in the drawings to denote like elements and features.

### DETAILED DESCRIPTION OF VARIOUS EMBODIMENTS

Accordingly in one aspect there is provided a computer server system comprising a communications module; a processor coupled with the communications module; and a memory coupled to the processor and storing processor-executable instructions which, when executed by the processor, configure the processor to analyze resource consumption data to identify at least one emerging resource requester; generate at least one trigger category that includes the at least one emerging resource requester and at least one other resource requester; receive, via the communications module and from a computing device, a request to present the at least one trigger category; and send, via the communications module and to the computing device, a signal causing the computing device to display an interface that includes a selectable option to accept the at least one trigger category.

In one or more embodiments, the instructions, when executed by the processor, further configure the processor to receive, via the communications module and from the computing device, a signal indicating selection of the selectable option to accept the at least one trigger category; monitor resource consumption data to identify resources being provided to at least one resource requester of the at least one trigger category; and responsive to identifying resources being provided to at least one resource requester of the at least one trigger category, trigger an action.

In one or more embodiments, the action includes determining an amount of a first type of resources provided to the at least one resource requester of the at least one trigger category; and providing an amount of a second type of resources to at least one resource collector.

In one or more embodiments, the amount of the second type of resources provided to the at least one resource collector is determined based on a modifier between the first type of resources and the second type of resources.

In one or more embodiments, the modifier is associated with the at least one trigger category.

In one or more embodiments, the action includes applying a modifier to resources provided to the at least one resource requester of the at least one trigger category.

In one or more embodiments, the action includes reducing an amount of resources provided to at least one resource requester that is not included in the at least one trigger category.

In one or more embodiments, the at least one emerging resource requester and the at least one other resource requester share a common characteristic and the common characteristic is associated with the at least one trigger category.

In one or more embodiments, the instructions, when executed by the processor, further configure the processor to responsive to receiving the request to present the at least one trigger category, select the at least one trigger category based on a user of the computing device sharing the common characteristic with the at least one trigger category.

In one or more embodiments, when identifying the at least one emerging resource requester, the instructions, when executed by the processor, further configure the processor to determine, from the resource consumption data, an increased rate of resource consumption of the at least one emerging resource requester.

In one or more embodiments, the resource consumption data includes resource consumption data obtained from a plurality of computing devices and stored in a database.

According to another aspect there is provided a computer-implemented method comprising analyzing resource consumption data to identify at least one emerging resource requester; generating at least one trigger category that includes the at least one emerging resource requester and at least one other resource requester; receiving, via a communications module and from a computing device, a request to present the at least one trigger category; and sending, via the communications module and to the computing device, a signal causing the computing device to display an interface that includes a selectable option to accept the at least one trigger category.

In one or more embodiments, the method further comprises receiving, via the communications module and from the computing device, a signal indicating selection of the selectable option to accept the at least one trigger category; monitoring resource consumption data to identify resources being provided to at least one resource requester of the at least one trigger category; and responsive to identifying resources being provided to at least one resource requester of the at least one trigger category, triggering an action.

In one or more embodiments, the action includes determining an amount of a first type of resources provided to the at least one resource requester of the at least one trigger category; and providing an amount of a second type of resources to at least one resource collector.

In one or more embodiments, the amount of the second type of resources provided to the at least one resource collector is determined based on a modifier between the first type of resources and the second type of resources.

In one or more embodiments, the modifier is associated with the at least one trigger category.

In one or more embodiments, the action includes reducing an amount of resources provided to at least one resource requester that is not included in the at least one trigger category.

In one or more embodiments, the at least one emerging resource requester and the at least one other resource requester share a common characteristic and the common characteristic is associated with the at least one trigger category.

In one or more embodiments, when identifying the at least one emerging resource requester, the method comprises determining, from the resource consumption data, an increased rate of resource consumption of the at least one emerging resource requester.

According to another aspect there is provided a non-transitory computer readable storage medium comprising computer-executable instructions which, when executed, configure a processor to analyze resource consumption data to identify at least one emerging resource requester; generate at least one trigger category that includes the at least one emerging resource requester and at least one other resource requester; receive, via a communications module and from a computing device, a request to present the at least one trigger category; and send, via the communications module and to the computing device, a signal causing the computing device to display an interface that includes a selectable option to accept the at least one trigger category.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

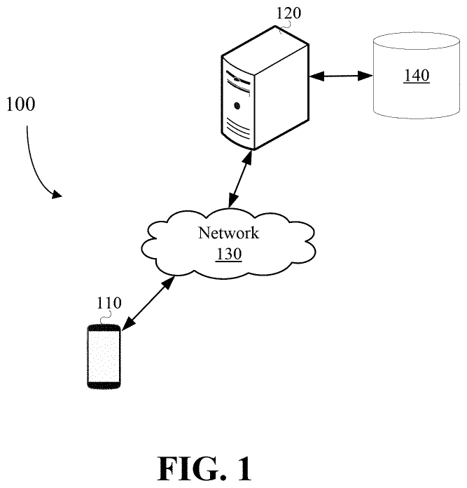

FIG. 1 is a schematic operation diagram illustrating an operating environment of an example embodiment. As shown, the system 100 includes a computing device 110 and a server 120 coupled to one another through a network 130, which may include a public network such as the Internet and/or a private network. The computing device 110 and the server 120 may be in geographically disparate locations. Put differently, the computing device 110 and the server 120 may be located remote from one another.

The computing device 110 may be a smartphone as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

The computing device 110 may be adapted to receive, from the server 120, a signal that causes the computing device 110 to display an interface that allows for communication with the server 120.

The server 120 may be associated with or may communicate with a database 140 that stores data records. The data records may include resource consumption data that includes a list of resource requesters and an amount of resources provided to the resource requesters. The data records may be updated or maintained by the server 120 and this may be done each time resources are provided to a resource requester.

In at least some embodiments, the resource consumption data may include a list of resource collectors and an amount of resources collected by the resource collectors. The resources provided to the resource collectors may be of a different type than the resources provided to the resource requesters. For example, a first type of resources may be provided to the resource requesters and a second type of resources may be provided to the resource collectors. The amount of resources provided to the resource collectors may be associated with or based on the amount of resources provided to the resource requesters. For example, the amount of resources provided to the resource collectors may be determined based on a modifier between the first type of resources and the second type of resources.

The server 120 may communicate with the database 140 directly or through the network 130. The server 120 may communicate with one or more third party servers through the network 130 and the one or more third party servers may be associated with resource requesters and/or resource collectors.

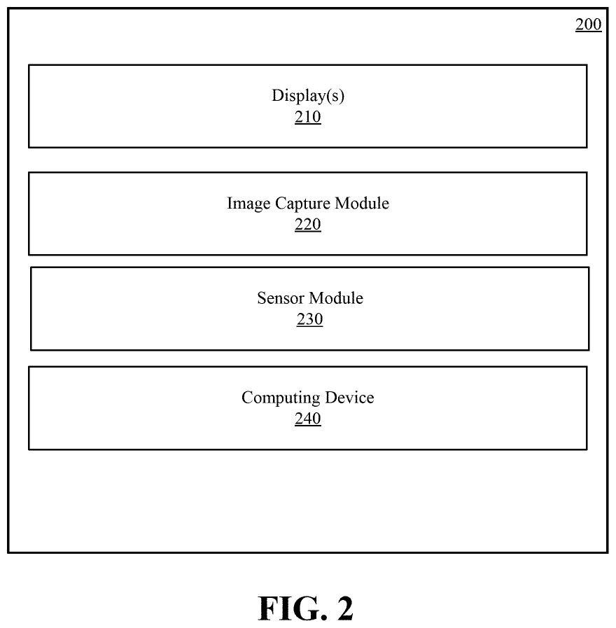

FIG. 2 is a simplified schematic diagram showing components of an exemplary computing device 200. The computing device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal—oxide—semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

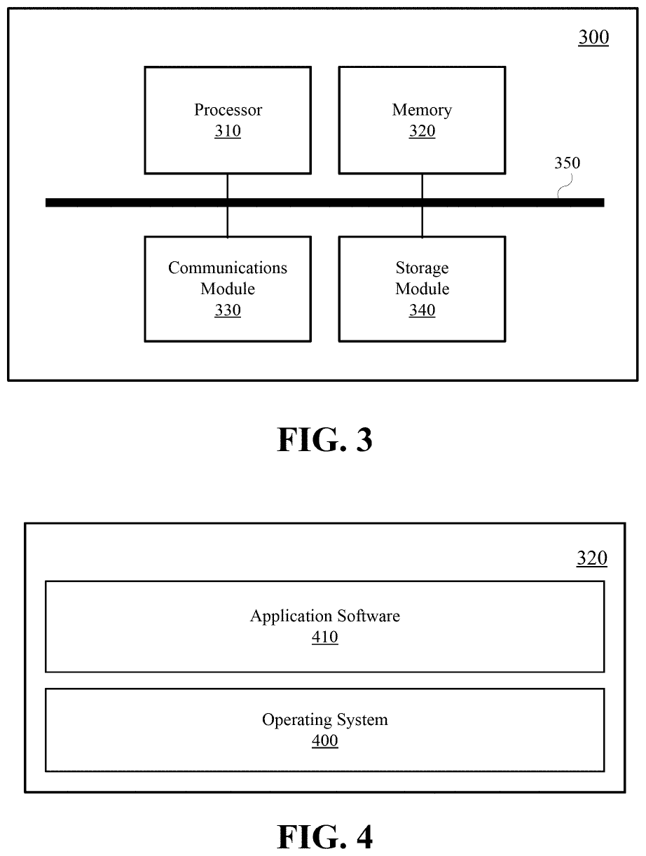

Referring now to FIG. 3, a high-level operation diagram of an example computer device 300 is shown. In some embodiments, the computer device 300 may be exemplary of the computer device 240 (FIG. 2) and/or server 120.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2) and/or the server 120.

While a single application 410 is illustrated in FIG. 3, in operation the memory 320 may include more than one application 410 and different applications 410 may perform different operations. For example, in at least some embodiments in which the computer device 300 is functioning as the computing device 110, the applications 410 may include a resource management application.

The resource management application may be configured to present one or more graphical user interfaces on a display of the computing device 110 and may provide various resource management functions. The resource management functions may include monitoring resource consumption data and/or defining trigger categories of resource requesters. For example, the resource management application may allow a user to request presentation of one or more trigger categories of resource requesters. The user may select one or more of the trigger categories and actions may be triggered based on the user selection.

The computing device 110 and/or the server 120 may obtain resource consumption data that includes a list of resource requesters and an amount of resources provided to the resource requesters. For example, the computing device 110 may identify a list of applications executing thereon and may determine the amount of computing resources being consumed by the applications. In this example, the computing resources may include a number of different types of resources such as for example total processor utilization, physical memory in use, disk utilization, network utilization, graphic processing unit (GPU) utilization, and power usage. In one or more embodiments, the resource consumption data may be obtained from a computing resource applications executing on the computing device 110.

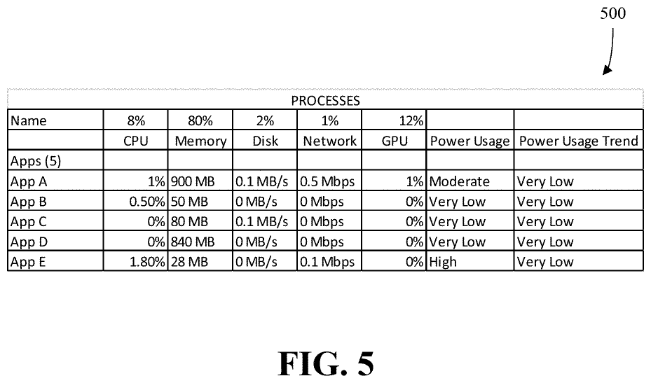

An example table 500 that includes resource consumption data is shown in FIG. 5. In this example, the resource requesters include applications executing on the computing device 110. As such, the table 500 includes a list of applications (“App A”, “App B”, “App C”, “App D”, “App E”) and resource consumption data identifying an amount of computing resources being consumed by each application. The resource consumption data may be obtained in real-time and as such the amount of computing resources being consumed by each application include a current amount of computing resource being consumed. The computing device 110 may store the resource consumption data in memory and/or may communicate the resource consumption data to the server 120 where it may be stored in the database 140. Although the resource consumption data is shown in FIG. 5 as a current amount of computing resources being consumed by each application, it will be appreciated that the computing device 110 may calculate or determine an average amount of resources being consumed by each application and the resource consumption data may include the average amount of resources being consumed by each application.

In one or more embodiments, the resource consumption data may be associated with a first type of resources. For example, the first type of resources may include network bandwidth. As such, the computing device 110 and/or the server 120 may generate the resource consumption data to include a list of resource requesters and an amount of network bandwidth consumed by each application. As another example, the first type of resources may include a value such as a quantity of resources stored in a resource account maintained by the database 140. In this example, the resource requesters may include third party resource accounts that request or otherwise receive resources from the resource account. The amount of resources requested by the resource requesters may be based on, for example, a transaction conducted between the third party and a user associated with the resource account.

In one or more embodiments, the server 120 may obtain resource consumption data from a plurality of computing devices and/or third party servers. The server 120 may consolidate the resource consumption data received from the plurality of computing devices and/or third party servers and may store the resource consumption data in the database 140.

The resource consumption data may include historical resource consumption data. For example, the resource consumption data may include historical transaction data. In this example, the server 120 and/or the database 140 may be associated with an entity such as for example a financial institution and the historical transaction data may obtained from accounts hosted by the financial institution.

The server 120 and/or the computing device 110 may analyze the resource consumption data to generate one or more trigger categories of resource requesters. A trigger category includes two or more resource requesters and is generated by the server 120 such that one or more actions are triggered when resources are provided to a resource requester that is included in the trigger category.

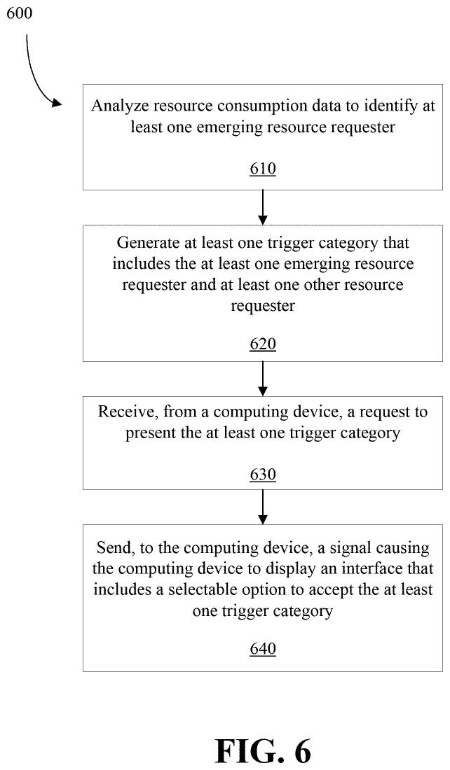

Reference is made to FIG. 6, which illustrates, in flowchart form, a method 600 for generating at least one trigger category. The method 600 may be implemented by a computing device having suitable processor-executable instructions for causing the computing device to carry out the described operations. The method 600 may be implemented, in whole or in part, by the server 120. The server 120 may off-load some of the operations to the computing device 110.

The method 600 includes analyzing resource consumption data to identify at least one emerging resource requester (step 610).

The resource consumption data is analyzed to identify one or more emerging resource requesters. An emerging resource requester may include a resource requester that has an increased rate of resource consumption and/or a resource requester that has an increased amount of resource consumption.

In one or more embodiments, the server 120 may analyze the resource consumption data to identify a resource requester that has an increased rate of resource consumption. In this embodiment, the server 120 may determine a rate at which resources are requested by each resource requester and may identify one or more resource requesters as having an increased rate. For example, the server 120 may determine that a particular resource requester requested resources four hundred (400) times in a first time period and that the particular resource requester requested resources one thousand (1000) times in a second period and may identify the particular resource requester as an emerging resource requester.

In one or more embodiments, the server 120 may analyze the resource consumption data to identify a resource requester that has an increased amount of resource consumption. In this embodiment, the server 120 may determine an average amount of resources consumed by each resource requester. The server 120 may analyze resource consumption and compare a current amount of resource consumption to the average amount of resource consumption and may identify an emerging resource requester when the difference between the current amount of resource consumption and the average amount of resource consumption exceeds a threshold. For example, the server 120 may determine that a particular application has an average download bandwidth of 25 Mbps and has a current download bandwidth of 100 Mbps and that the difference between the average download bandwidth and the current download bandwidth exceeds a threshold of 50 Mbps. As such, the server 120 may identify the particular application as an emerging resource requester.

The method 600 includes generating at least one trigger category that includes the at least one emerging resource requester and at least one other resource requester (step 620).

As mentioned, a trigger category includes two or more resource requesters and is generated by the server 120 such that one or more actions are triggered when resources are provided to a resource requester that is included in the trigger category.

In this embodiment, a trigger category is generated that includes the at least one emerging resource requester and at least one other resource requester. For example, a resource requester identified as an emerging resource requester during step 610 may be included in the trigger category.

The server 120 may select the at least one other resource requester. In one or more embodiments, the server 120 may select the at least one other resource requester by determining that the at least one other resource requester shares a common characteristic with the emerging resource requester.

The common characteristic may include a similar amount of resource consumption. For example, the emerging resource requester may consume an amount of a first type of resources and the at least one other resource requester may consume a similar amount of the first type of resources.

The common characteristic may include being associated with a particular demographic. For example, the server 120 may analyze the resource consumption data to identify a particular demographic of users that have the emerging resource consumer installed on their computing device. The server 120 may select the at least one other resource requester based on the at least one other resource requester being associated with the particular demographic identified for the emerging resource requester. Example demographics include location (neighbourhood, city, province, state, country, etc.), age, gender, marital status, profession, etc.

The common characteristic may include being associated with a particular category. For example, the server 120 may identify that the emerging resource requester is an application associated with food delivery. The server 120 may select the at least one other resource requester based on the at least one other resource requester being associated with the particular category of food delivery. In another example, the server 120 may select the at least one other resource requester based on the at least one other resource requester being associated with a category that is complementary to the particular category. For example, a category complementary to food delivery may be video streaming and as such the server 120 may select the at least one other resource requester as being an application that may be used for video streaming. As such, the trigger category may include the application associated with food delivery and the application associated with video streaming. Other examples of categories may include travel, hotel, e-commerce, fast food, gas, groceries, entertainment, ride sharing, food delivery, health and wellness, cosmetics, telecommunications, home improvement, etc. In another example, the emerging resource requester and/or the at least one other resource requester may be associated with a particular merchant or group of merchants and may share a common characteristic as described herein.

The common characteristic may include being flagged as a priority resource requester. For example, within the resource management application, the user may select one or more resource requesters as being priority resource requesters. The server 120 may include the emerging resource requester with one or more other resource requesters and as such the trigger category may include the emerging resource requester and one or more other resource requesters that are identified as being priority resource requesters. In one or more embodiments, responsive to identifying the at least one emerging resource requester, the server 120 may send a signal causing the computing device 110 to display a notification that identifies the at least one emerging resource requester and that includes a selectable option to flag the at least one emerging resource requester as a priority resource requester. Responsive to selection of the selectable option to flag the at least one emerging resource requester as the priority resource requester, the computing device 110 may send a signal to the server 120 indicating selection of the selectable option and in response the server 120 may add the at least one emerging resource requester to a trigger category that includes one or more other priority resource requesters.

The common characteristic may be associated with the trigger category such that all resource requesters within the trigger category share the common characteristic.

It will be appreciated that multiple trigger categories may be generated and that the at least one emerging resource requester may be included in more than one trigger category. In one or more embodiments, once a trigger category has been generated, one or more additional resource requesters may be added to the trigger category and this may be done by the user within the resource management application or may be done by the server 120 in response to, for example, identifying one or more additional emerging resource requesters.

The method 600 includes receiving, from the computing device, a request to present the at least one trigger category (step 630).

In one or more embodiments, the resource management application may display, on the computing device 110, a graphical user interface that includes a selectable option to present at least one trigger category. The user may select the selectable option by performing, for example, a tap gesture on a display screen of the computing device 110. Responsive to selection of the selectable option, the computing device 110 may send a signal to the server 120 representing a request to present the at least one trigger category.

In one or more embodiments, responsive to receiving the request to present the at least one trigger category, the at least one trigger category may be selected based on a user of the computing device sharing the common characteristic with the at least one category. For example, a particular trigger category may be associated with a particular characteristic or demographic and as such the particular trigger category may be selected based on a user of the computing device sharing the particular characteristic or demographic with the trigger category.

The method 600 includes sending, to the computing device, a signal causing the computing device to display an interface that includes a selectable option to accept the at least one trigger category (step 640).

Responsive to selection of the selectable option to request presentation of the at least one trigger category, the server 120 receives the signal from the computing device 110 representing the request to present the at least one trigger category. The server 120 sends a signal to the computing device 110 causing the computing device 110 to display an interface. The interface may be a graphical user interface.

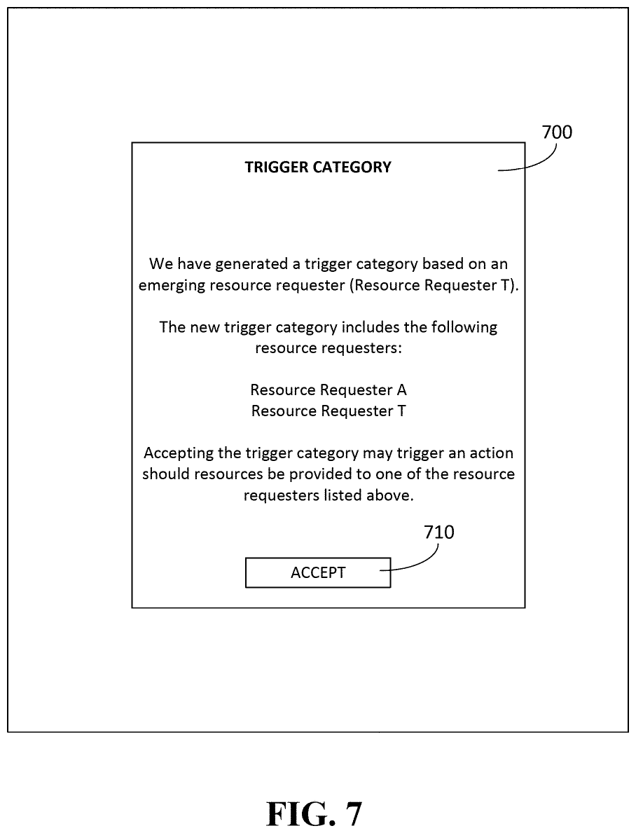

An example interface 700 is shown in FIG. 7. As can be seen, the interface 700 includes information identifying the trigger category and a selectable option 710 to accept the trigger category. In this example, the trigger category includes an emerging resource requester (“Resource Requester T”) and one other resource requester (“Resource Requester A”).

The interface 700 is displayed on a display screen of the computing device 110. The interface 700 may be displayed within the resource management application or may be displayed as a notification. For example, the interface 700 may be displayed within a notification center of an operating system executing on the computing device 110.

The user may accept the trigger category by selecting the selectable option 710. Once a trigger category has been accepted, one or more actions are triggered in response to resources being provided to at least one resource requester of the trigger category.

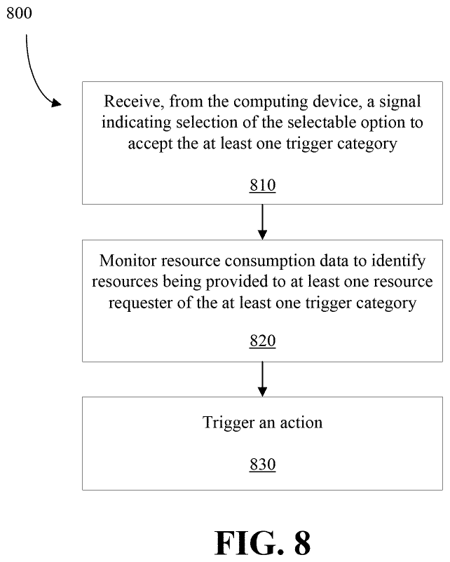

Reference is made to FIG. 8, which illustrates, in flowchart form, a method 800 for triggering an action. The method 800 may be implemented by a computing device having suitable processor-executable instructions for causing the computing device to carry out the described operations. The method 800 may be implemented, in whole or in part, by the server 120. The server 120 may off-load some of the operations to the computing device 110.

The method 800 includes receiving, from the computing device, a signal indicating selection of the selectable option to accept the at least one trigger category (step 810).

Responsive to selection of the selectable option to accept the at least one trigger category, the computing device 110 sends a signal to the server 120 indicating selection of the selectable option. The signal is received by the server 120.

Responsive to receiving the signal indicating selection of the selectable option to accept the at least one trigger category, the server 120 may store data in memory or a database that includes information relating to the trigger category such as for example data identifying the at least one emerging resource requester and the at least one other resource requester. It will be appreciated that in one or more embodiments, the data may additionally or alternatively be stored in memory of the computing device 110. In the example shown in FIG. 7, responsive to selection of the selectable option 710, the data may include information identifying the Resource Requester A and the Resource Requester T.

The method 800 includes monitoring resource consumption data to identify resources being provided to at least one resource requester of the at least one trigger category (step 820).

The resource consumption data includes a list of resource requesters and an amount of resources provided to the resource requesters. Each time resources are provided to a resource requester, the resource consumption data may be updated. As the resource consumption data is updated, the server 120 and/or computing device 110 may monitor the resource consumption data to identify resources provided to at least one requester of the at least one trigger category. In the example shown in FIG. 7, resource consumption data may be monitored to identify when resources are provided to Resource Requester A and/or Resource Requester T.

Responsive to identifying that resources are provided to at least one requester of the at least one trigger category, the method 800 includes triggering an action (step 830).

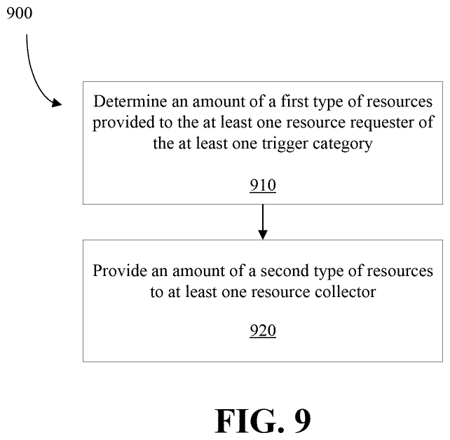

In one or more embodiments, the action may include providing an amount of a second type of resources to at least one resource collector. Reference is made to FIG. 9, which illustrates, in flowchart form, a method 900 for providing an amount of a second type of resources to at least one resource collector. The method 900 may be implemented by a computing device having suitable processor-executable instructions for causing the computing device to carry out the described operations. The method 900 may be implemented, in whole or in part, by the server 120. The server 120 may off-load some of the operations to the computing device 110.

The method 900 includes determining an amount of a first type of resources provided to the at least one resource requester of the at least one trigger category (step 910).

As mentioned, the resource consumption data includes a list of resource requesters and an amount of resources provided to the resource requesters. The amount of resources provided to the resource requesters may be a first type of resources. When it is determined that resources are being provided to at least one resource requester of the at least one trigger category, the amount of resources being provided to the at least one resource requester is determined from the resource consumption data.

The first type of resources may be a computing resource such as network bandwidth, total processor utilization, physical memory in use, disk utilization, network utilization, graphic processing unit (GPU) utilization, and power usage. The first type of resource may represent a value such as a quantity of a first type of resource stored in a data record. As such, it may be determined that an amount of the first type of resource is being provided from the data record to a data record associated with a resource requester.

The method 900 includes providing an amount of a second type of resources to at least one resource collector (step 920).

In this embodiment, a resource collector may include a computer process, an application or a data record that may collect or store resources.

The second type of resources may be related to the first type of resources. For example, the first type of resources may include a first type of computing resources and the second type of resources may be a second type of computing resources. As another example, the first type of resources may represent a quantity of a first type of resource such as for example currency and the second type of resources may represent a quantity of a second type of resources such as for example loyalty points.

In one or more embodiments, the amount of the second type of resources may be determined based on the amount of the first type of resources. For example, the first type of resources may represent an amount of resources of a first type being provided to a data record associated with a resource requester. The amount of the second type of resources may be determined based on a modifier between the first type of resources and the second type of resources. The modifier may be a multiplier such as 2× and as such for every one (1) of the first type of resources provided to the resource requester two (2) of the second type of resources may be provided to the resource collector. Other example multipliers may include 1×, 5×, 10×, etc. The modifier may be particular for each trigger category.

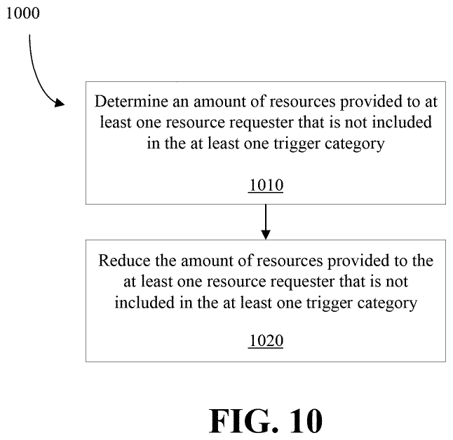

In one or more embodiments, the action may include reducing the amount of resources provided to at least one resource requester that is not included in the at least one trigger category. Reference is made to FIG. 10, which illustrates, in flowchart form, a method 1000 for reducing the amount of resources provided to at least one resource requester that is not included in the at least one trigger category. The method 1000 may be implemented by a computing device having suitable processor-executable instructions for causing the computing device to carry out the described operations. The method 1000 may be implemented, in whole or in part, by the server 120. The server 120 may off-load some of the operations to the computing device 110.

The method 1000 includes determining an amount of resources provided to at least one resource requester that is not included in the at least one trigger category (step 1010).

As mentioned, the resource consumption data includes a list of resource requesters and an amount of resources provided to the resource requesters. As such, the server 120 and/or computing device 110 may determine, from the resource consumption data, an amount of resources being provided to at least one resource requester that is not included in the at least one trigger category.

The method 1000 includes reducing the amount of resources provided to the at least one resource requester that is not included in the at least one trigger category (step 1020).

The server 120 and/or computing device 110 may reduce the amount of resources provided to the at least one resource requester that is not included in the at least one trigger category. In one example, the trigger category may include resource requesters that are identified as priority resource requesters. As such, when it is determined that resources are being provided to one or more priority resource requesters, the server 120 and/or computing device 110 may reduce the amount of resources provided to the at least one resource requester that is not included in the at least one trigger category.

As mentioned, the resources may include computing resources such as network bandwidth, total processor utilization, physical memory in use, disk utilization, network utilization, graphic processing unit (GPU) utilization, power usage, etc. In this manner, triggering an action to reduce the amount of computing resources provided to a resource requester that is not a priority resource requester may maximize or otherwise increase the amount of computing resources available to one or more resource requesters included in the trigger category.

In another embodiment, the action may include additionally applying a modifier to resources provided to at least one resource requester that is not included in the at least one trigger category. For example, the modifier may be a multiplier of 0.5× and as such a reduced amount of resources may be provided to the at least one resource requester that is not included in the at least one trigger category. The modifier may be particular to each trigger category.

The resource management application may include additional features such as for example a selectable option to share a selected trigger category on one or more social media sites. Specifically, a user may create a social media post that includes information identifying the trigger category. The social media post may include a selectable option or a selectable link that allows one or more other users to select the trigger category. In this manner, the one or more other users may select the trigger category even if the one or more other users do not share the common characteristic associated with the trigger category.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer server system comprising:
a communications module;
a processor coupled with the communications module; and
a memory coupled to the processor and storing processor-executable instructions which, when executed by the processor, configure the processor to:
analyze resource consumption data to identify at least one emerging resource requester;
generate at least one trigger category that includes the at least one emerging resource requester and at least one other resource requester;
receive, via the communications module and from a computing device, a request to present the at least one trigger category; and
send, via the communications module and to the computing device, a signal causing the computing device to display an interface that includes a selectable option to accept the at least one trigger category.

2. The computer server system of claim 1, wherein the instructions, when executed by the processor, further configure the processor to:
receive, via the communications module and from the computing device, a signal indicating selection of the selectable option to accept the at least one trigger category;
monitor resource consumption data to identify resources being provided to at least one resource requester of the at least one trigger category; and
responsive to identifying resources being provided to at least one resource requester of the at least one trigger category, trigger an action.

3. The computer server system of claim 2, wherein the action includes:
determining an amount of a first type of resources provided to the at least one resource requester of the at least one trigger category; and
providing an amount of a second type of resources to at least one resource collector.

4. The computer server system of claim 3, wherein the amount of the second type of resources provided to the at least one resource collector is determined based on a modifier between the first type of resources and the second type of resources.

5. The computer server system of claim 4, wherein the modifier is associated with the at least one trigger category.

6. The computer server system of claim 2, wherein the action includes:
applying a modifier to resources provided to the at least one resource requester of the at least one trigger category.

7. The computer server system of claim 2, wherein the action includes:
reducing an amount of resources provided to at least one resource requester that is not included in the at least one trigger category.

8. The computer server system of claim 1, wherein the at least one emerging resource requester and the at least one other resource requester share a common characteristic and the common characteristic is associated with the at least one trigger category.

9. The computer server system of claim 8, wherein the instructions, when executed by the processor, further configure the processor to:
responsive to receiving the request to present the at least one trigger category, select the at least one trigger category based on a user of the computing device sharing the common characteristic with the at least one trigger category.

10. The computer server system of claim 1, wherein when identifying the at least one emerging resource requester, the instructions, when executed by the processor, further configure the processor to:
determine, from the resource consumption data, an increased rate of resource consumption of the at least one emerging resource requester.

11. The computer server system of claim 1, wherein the resource consumption data includes resource consumption data obtained from a plurality of computing devices and stored in a database.

12. A computer-implemented method comprising:
analyzing resource consumption data to identify at least one emerging resource requester;
generating at least one trigger category that includes the at least one emerging resource requester and at least one other resource requester;
receiving, via a communications module and from a computing device, a request to present the at least one trigger category; and
sending, via the communications module and to the computing device, a signal causing the computing device to display an interface that includes a selectable option to accept the at least one trigger category.

13. The computer-implemented method of claim 12, further comprising:
receiving, via the communications module and from the computing device, a signal indicating selection of the selectable option to accept the at least one trigger category;
monitoring resource consumption data to identify resources being provided to at least one resource requester of the at least one trigger category; and
responsive to identifying resources being provided to at least one resource requester of the at least one trigger category, triggering an action.

14. The computer-implemented method of claim 13, wherein the action includes:
determining an amount of a first type of resources provided to the at least one resource requester of the at least one trigger category; and
providing an amount of a second type of resources to at least one resource collector.

15. The computer-implemented method of claim 14, wherein the amount of the second type of resources provided to the at least one resource collector is determined based on a modifier between the first type of resources and the second type of resources.

16. The computer-implemented method of claim 15, wherein the modifier is associated with the at least one trigger category.

17. The computer-implemented method of claim 13, wherein the action includes:
reducing an amount of resources provided to at least one resource requester that is not included in the at least one trigger category.

18. The computer-implemented method of claim 12, wherein the at least one emerging resource requester and the at least one other resource requester share a common characteristic and the common characteristic is associated with the at least one trigger category.

19. The computer-implemented method of claim 12, wherein when identifying the at least one emerging resource requester, the method comprises:
determining, from the resource consumption data, an increased rate of resource consumption of the at least one emerging resource requester.

20. A non-transitory computer readable storage medium comprising computer-executable instructions which, when executed, configure a processor to:
analyze resource consumption data to identify at least one emerging resource requester;
generate at least one trigger category that includes the at least one emerging resource requester and at least one other resource requester;
receive, via a communications module and from a computing device, a request to present the at least one trigger category; and
send, via the communications module and to the computing device, a signal causing the computing device to display an interface that includes a selectable option to accept the at least one trigger category.
